(19) United States
(12) Patent Application Publication
(10) Pub. No.: US 2011/0119136 A1
(43) Pub. Date: May 19, 2011

(54) Advertising Forecast and Revenue Systems and Methods

(76) Inventors: John Paul Eldreth, Chantilly, VA (US); Christopher Guy Passante, Great Falls, VA (US)

(21) Appl. No.: 13/001,772

(22) PCT Filed: Jun. 17, 2009
(86) PCT No.: PCT/US09/47686

§ 371 Date: Dec. 28, 2010

Related U.S. Application Data
(60) Provisional application No. 61/129,554, filed on Jul. 3, 2008.

(51) Int. Cl. G06Q 30/00

(52) U.S. Cl. 705/14.69

(57) ABSTRACT

A computer-implemented method is provided for forecasting a value of an available targeted inventory associated with an advertising space. The method includes obtaining historical data associated with the advertising space, and determining, for the advertising space, a total forecast value corresponding to a predetermined interval of future time. The method also includes determining a total booked value and a total availability value based on the total booked value and the total forecast value, corresponding to the predetermined interval of future time. The method also includes determining, for the advertising space, a population composition percentage value based on one or more population composition rules, and a population composition availability value based on the population composition percentage value. The method further includes determining the value of the available targeted inventory associated with the advertising space for the predetermined interval of future time based on the population composition availability.

### PRIORITY

This application claims the benefit of priority of U.S. Provisional Application No. 61/129,554, filed Jul. 3, 2008, and titled “ADVERTISING FORECAST AND REVENUE SYSTEMS AND METHODS,” the entire contents of which are incorporated herein by reference in its entirety.

### TECHNICAL FIELD

The present disclosure is directed to a system and method for advertising and, more particularly, to a system and method for advertising forecast and revenue.

### BACKGROUND

With the increasing improvements to the world wide web, i.e., the Internet, consumers are spending more time accessing online Internet content, including, for example, viewing web pages, searching for information, social networking, and shopping. Recognizing the changes in consumer behavior and the importance of online communities, companies across a diverse set of industries are allocating increasing amounts of their budgets to online advertising in an effort to promote their services and/or products. Toward that end, a marketer representing a company seeking to promote services and/or products through online advertising, may purchase, from an online advertising service provider, advertising spaces (or spots) embedded in, or displayed in connection with, web pages.

When selling advertising, the online advertising service provider may need to know how much inventory is available for sale. The inventory may include a total number of advertising spaces available for sale, or a total number of impressions associated with an advertising space available for sale. An impression may be defined in various ways. For example, an impression may be defined as a display, a view, or a click of an advertisement. For simplicity and discussion purposes, hereinafter, an impression is defined as a view of an advertisement by a viewer.

Forecasting the availability of inventory may help the online advertising service provider determine price and forecast revenue. Various forecasting systems have been developed to predict the total availability of the inventory and/or to predict revenue. Some traditional forecasting systems predict a raw inventory, e.g., the total number of raw impressions that are available for sale, without taking into account existing purchases of impressions, or predict untargeted inventory without considering constraints placed by population composition rules associated with proposed purchases from the marketer. As a result, some traditional forecasting systems may not accurately estimate the available inventory.

The system and method of the present disclosure are directed toward improvements in the existing advertising forecast and revenue technology.

### SUMMARY

In one embodiment, the present disclosure is directed to a computer-implemented method for forecasting a value of an available targeted inventory associated with an advertising space. The computer-implemented method includes obtaining historical data associated with the advertising space. The computer-implemented method also includes determining, by a processor, for the advertising space, a total forecast value corresponding to a predetermined interval of future time. The total forecast value is based on the historical data. The computer-implemented method also includes determining, by the processor, for the advertising space, a total booked value corresponding to the predetermined interval of future time. The computer-implemented method also includes determining, by the processor, for the predetermined interval of future time, a total availability value based on the total booked value and the total forecast value. The computer-implemented method also includes determining, by a processor, for the advertising space, a population composition percentage value based on one or more population composition rules. The computer-implemented method also includes determining, by a processor, for the predetermined interval of future time, a population composition availability value based on the population composition percentage value. The computer-implemented method further includes determining, by the processor, the value of the available targeted inventory associated with the advertising space for the predetermined interval of future time based on the population composition availability.

In another embodiment, the present disclosure is directed to a computer-implemented method for obtaining a forecasted inventory value associated with an advertising space and corresponding to a targeted population. The computer-implemented method includes obtaining historical data associated with the advertising space. The computer-implemented method also includes determining, by the processor, one or more forecast values associated with a predetermined interval of future time based on the historical data and one or more forecasting models. The computer-implemented method also includes determining, by the processor, a gross forecast value based on the one or more forecast values for the predetermined interval of future time. The computer-implemented method also includes determining, by a processor, one or more population composition values based on the historical data. The computer-implemented method also includes modifying, by the processor, the gross forecast value based on at least one of the one or more population composition values. The computer-implemented method further includes determining, by a processor, a net forecast value corresponding to the targeted population for the predetermined interval of future time based on the modified gross forecast value.

In another embodiment, the present disclosure is directed to a computer-implemented method for forecasting revenue associated with an advertising space. The computer-implemented method includes obtaining historical data associated with the advertising space. The computer-implemented method also includes determining, by the processor, one or more forecast values based on the historical data and one or more forecasting models. The computer-implemented method also includes determining, by the processor, a gross forecast value based on the one or more forecast values for a predetermined interval of future time. The computer-implemented method also includes determining, by the processor, one or more rule values based on the historical data. The computer-implemented method also includes determining, by the processor, a net forecast value corresponding to a targeted population at the predetermined interval of future time based on at least one of the one or more rule values and the gross forecast value. The computer-implemented method also includes determining, by the processor, an historical revenue value associated with the advertising space based on the at least one of the one or more rule values. The computer-implemented method further includes determining, by the processor, a forecasted revenue value based on the net forecast value and the historical revenue value for the predetermined interval of future time.

In another embodiment, the present disclosure is directed to a computer readable medium embodying a computer program product. The computer program product includes computer program code configured to cause a computing device to perform a method for forecasting a value of available targeted inventory associated with an advertising space. The method includes obtaining historical data associated with the advertising space. The method also includes determining, for the advertising space, a total forecast value corresponding to a predetermined interval of future time. The total forecast value is based on the historical data. The method also includes determining, for the advertising space, a total booked value corresponding to the predetermined interval of future time. The method also includes determining, for the predetermined interval of future time, a total availability value based on the total booked value and the total forecast value. The method also includes determining, for the advertising space, a population composition percentage value based on one or more population composition rules. The method also includes determining, for the predetermined interval of future time, a population composition availability value based on the population composition percentage value. The method further includes determining the value of the available targeted inventory associated with the advertising space for the predetermined interval of future time based on the population composition availability.

In another embodiment, the present disclosure is directed to a system for forecasting a value of an available targeted inventory associated with an advertising space. The system includes at least one memory to store data and instructions. The system also includes at least one processor configured to access the at least one memory and, when executing the instructions, to determine, for the advertising space, a total forecast value corresponding to a predetermined interval of future time, wherein the total forecast value is based on the historical data. The at least one processor is also configured to determine, for the advertising space, a total booked value corresponding to the predetermined interval of future time. The at least one processor is also configured to determine, for the predetermined interval of future time, a total availability value based on the total booked value and the total forecast value. The at least one processor is also configured to determine, for the advertising space, a population composition percentage value based on one or more population composition rules. The at least one processor is also configured to determine, for the predetermined interval of future time, a population composition availability value based on the population composition percentage value. The at least one processor is further configured to determine the value of the available targeted inventory associated with the advertising space for the predetermined interval of future time based on the population composition availability.

### BRIEF DESCRIPTION OF THE DRAWINGS

FIG. 1 is a schematic of an exemplary system, consistent with certain disclosed embodiments;

FIG. 2 is a schematic of an exemplary advertising space, consistent with certain disclosed embodiments;

FIG. 3 is a schematic of an exemplary functional diagram for forecasting advertising values, consistent with certain disclosed embodiments;

FIG. 4 is a flow chart of an exemplary process for forecasting an availability of targeted inventory, consistent with certain disclosed embodiments;

FIG. 5 is a flow chart of an exemplary process for forecasting an inventory value, consistent with certain disclosed embodiments; and

FIG. 6 is a flow chart of an exemplary process for forecasting advertising revenue, consistent with certain disclosed embodiments.

### DETAILED DESCRIPTION

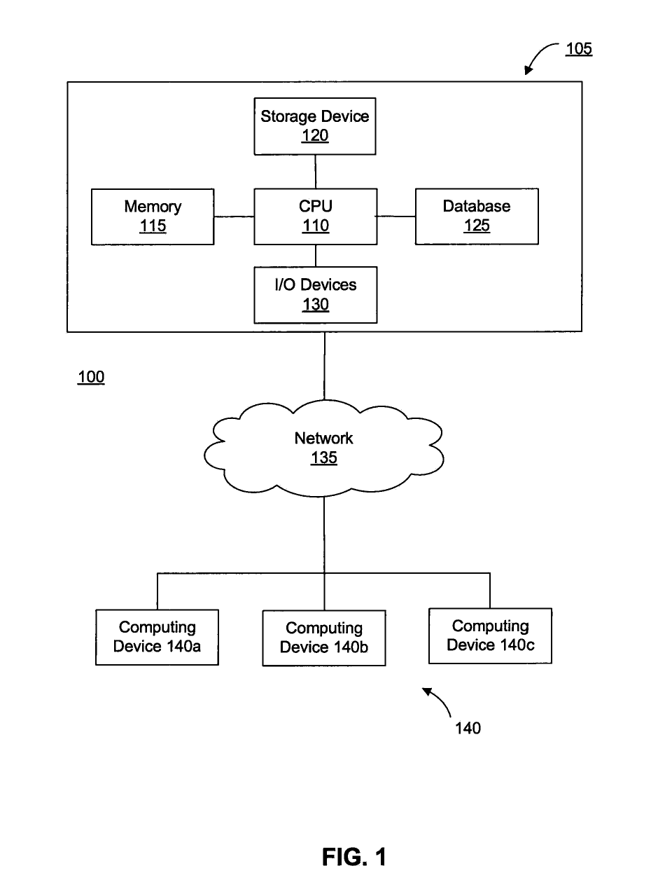

FIG. 1 is a schematic of an exemplary system 100 in which principles and methods consistent with the disclosed embodiments may be implemented. In some embodiments, system 100 may be owned or operated by the online advertising service provider. As shown in FIG. 1, system 100 may include one or more computers. As used herein, the term “computers” may encompass any device that is suitable for processing advertising data and/or displaying advertising data, such as, for example, a desktop computer, a laptop computer, a server, a workstation, a handheld device, a smart phone, a network computer, a terminal, an electronic display, etc.

As illustrated in FIG. 1, system 100 may include a server 105, one or more computing devices 140, such as computing device 140a, computing device 140b, and computing device 140c, and a network 135 configured to connect the server 105 and the one or more computing devices 140a, 140b, and 140c, and allow communication between or among server 105 and computing devices 140a, 140b, and 140c. One skilled in the art should recognize that system 100 may include a greater or lesser number of devices, and may include other suitable devices associated with advertising.

As shown in FIG. 1, server 105 may include one or more of the following components: at least one central processing unit (CPU) 110 configured to execute computer program instructions to perform various processes and methods, a memory 115, a database 125, 110 devices 130, etc. Although not shown, server 105 may include one or more display devices and/or one or more communication interfaces. In some embodiments, server 105 may be, for example, a general purpose computer, a workstation, or any suitable device configured to manage advertising. Server 105 may be configured to provide ads and web pages on which the ads may be displayed, store historical data associated with advertising, forecast availability of inventory, and provide revenue forecasting.

Memory 115 may be configured to store any data and/or instructions, such as, for example, data related to operating systems and executable program code that may be used by CPU 110. Memory 115 may be any type of suitable memory, for example, a random access memory (RAM), a read-only memory (ROM), flash memory, etc. CPU 110 may be configured to access memory 115 to obtain the instructions and/or program code stored thereon for execution by CPU 110.

Storage device 120 may be configured to store data, such as, for example, historical data including information associated with an ad and/or an advertising space (e.g., view counts, etc.), cookie data obtained from a viewer's browser, revenue data, pricing data, web page data, advertisement data, and any other suitable data. Storage device 120 may include any suitable storage device, such as, for example, a hard drive, an optical storage device, Compact Disk (CD) ROM, Digital Video Disk (DVD) ROM, a blue-ray storage device, a flash memory storage device, etc.

Database 125 may include one or more software and/or hardware components for storing, analyzing, and/or arranging data used by CPU 110 and/or other hardware/software components of system 100. Database 125 may be any suitable type of database, such as, for example, a relational type or a distributed type. Database 125 may also include hardware and/or software tools configured to analyze the data stored therein. Database 125 may be configured to store any suitable data related to advertising, for example, placements of ads, lists of advertising spaces, client information, pricing of ads and/or advertising spaces, and forecasted values associated with advertising spaces.

I/O devices 130 may include any suitable input/output devices, such as, for example, a keyboard, a mouse, a pointing device, an audio input device, a video input device, a USB input device, a display, etc. I/O devices 130 may be configured to receive an input, such as, for example, a request from a viewer or an instruction from an operator of server 105. I/O devices 130 may also be configured to output data. For example, I/O devices 130 may include a display for displaying a message, an output port configured to output data to other devices, such as a USB drive, a CD and/or DVD, or to the network 135 of the system 100. I/O devices 130 may include other peripheral devices, such as, for example, a printer, a speaker, and a camera.

Network 135 may be any suitable type of communication link, for example, the Internet, a local area network (LAN), a wide area network (WAN), a peer-to-peer network, a direct link network, a wired or wireless network, or other suitable communication platform known in the art. In one exemplary embodiment, network 135 may be configured to allow communication between or among any combination of server 105 and computing devices 140a, 140b, and 140c.

Computing devices 140a, 140b, and 140c may be any type of computer including software and/or hardware components configured to allow a user to access server 105 through network 135 and view data and/or information received from server 105. The data and/or information may be in any form, such as, for example, web pages, texts, audio and/or video clips, still and/or animated images. Although not shown, each of the computing devices 140a, 140b, and 140c may include one or more of the following components: at least one central processing unit (CPU) configured to execute computer program instructions to perform various processes and methods, memory, storage devices, databases, one or more I/O devices, one or more display devices, etc. Each of these components is well-known in the art and will not be discussed further.

In some embodiments, computing devices 140a, 140b, and 140c may be, for example, a desktop computer, a laptop computer, a server, a workstation, a handheld device, a smart phone, a network computer, a terminal, an electronic display, etc. In one embodiment, each of the computing devices 140a, 140b, and 140c may include a web page “browser” that allows the user to browse web pages. As used herein, when the user views an ad displayed on a web page, the user may be considered a viewer of the ad.

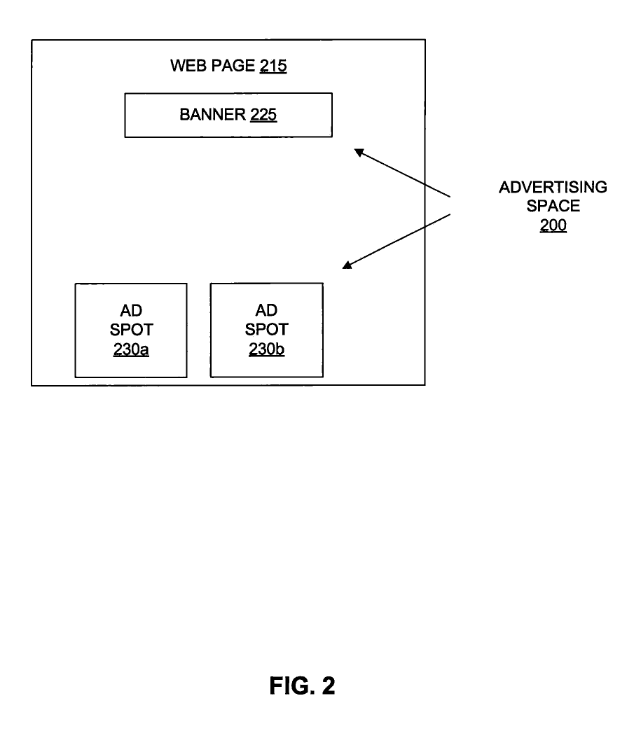

FIG. 2 is a schematic illustrating an exemplary advertising space 200. As shown in FIG. 2, advertising space 200 may be part of a web page 215. Generally, a web page is a document written in hypertext markup language (HTML) or the like, and translated by a web browser for display to a user. To access web page 215, a user, such as a user of computing device 140a, 140b, or 140c, may access web page 215 using a universal resource locator (URL) through the web browser. Web page 215 can be either static or dynamic. A static web page 215 is one that shows the same content each time it is viewed with the web browser, whereas a dynamic web page 215 is one in which the content may change each time it is displayed to a user. Web page 215 may be, for example, an instant messaging interface, an image viewing interface, a video viewing interface, an audio player interface, etc. As known in the art, a web site may be a collection of web pages.

Advertising space 200 may be a plurality of regions reserved for advertisements located on web page 215. Advertising space 200 may include one or more graphic images (e.g., Graphics Interchange Format (GIF) image, etc.), one or more animated graphic images (e.g., animated GIFs), banners, etc. For example, as schematically illustrated in FIG. 2, advertising space 200 may include a banner 225 and a plurality of ad spots 230, such as, for example, a first ad spot 230a and a second ad spot 230b. The first and second ad spots 230a and 230b, and banner 225 may have fixed positions on web page 215, or may be configured to be movable on web page 215 and may follow predetermined or random paths when web page 215 is displayed to the viewer.

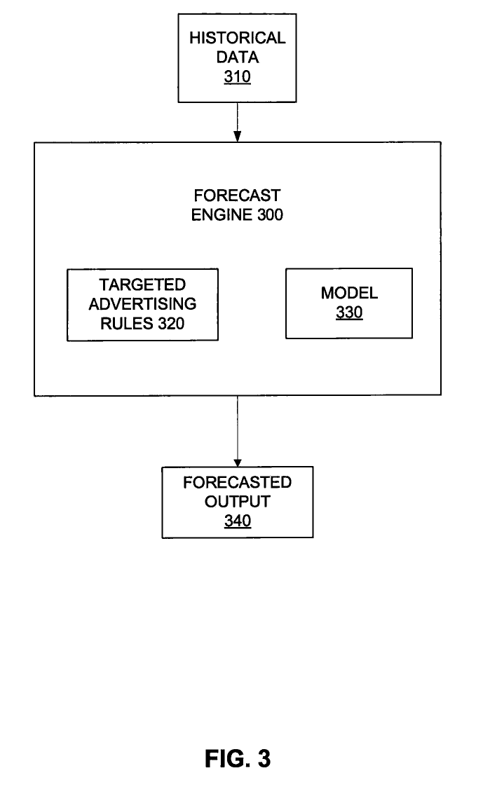

FIG. 3 is a schematic of an exemplary functional diagram of a system and method for forecasting values associated with advertising space 200, such as, for example, a total number of available impressions for sale, a total revenue value, etc. In one embodiment, system 100 may include a forecast engine 300 for performing forecasting of various values associated with advertising space 200. In one embodiment, forecast engine 300 may be a dedicated device encoded with executable program code for performing the forecast of advertising values. Forecast engine 300 may utilize at least one of CPU 110, database 125, storage device 120, memory 115, and I/O devices 130 shown in FIG. 1 to perform functions such as, for example, computing, analysis, and forecasting, and may output a forecasted output 340. In one exemplary embodiment, the forecasted output 340 may be a value indicating price associated with advertising space 200, a value of available targeted inventory associated with advertising space 200, a forecasted revenue value associated with advertising space 200, or any other suitable future value associated with advertising space 200.

In one exemplary embodiment, forecast engine 300 may be configured to obtain and analyze historical data 310 received from, for example, storage device 120. Historical data 310 may be raw historical data collected over a predetermined interval of historical time, such as, for example, hours, days, weeks, months, etc. Raw historical data may contain any suitable information regarding each impression (or view) of an ad over the predetermined interval of historical time. In one exemplary embodiment, historical data 310 may include a sampling of raw historical data using, for example, a predetermined sampling rate over the predetermined interval of historical time (e.g., sampled every two days in a twenty-eight day period). In other embodiments, historical data 310 may include a mix of un-sampled raw historical data and sampled raw historical data.

For example, historical data 310 may include a view count indicating a number of impressions (or views) associated with advertising space 200. The view count may be a raw value included in raw historical data, or a sampled value that is obtained by sampling the raw historical data at the predetermined sample rate. The view count may be based on any suitable predetermined interval of time. For example, the view count may be an hourly view count, a daily view count, and/or a monthly view count. In some embodiments, historical data 310 may include cookie records obtained from the web browsers of at least one of the computing devices 140a, 140b, and 140c.

As another example, historical data 310 may include information indicating date and time an advertisement is viewed, and information about the viewers, such as, for example, demographic and behavioral characteristics of the viewers. Demographic characteristics of the viewers may include information related to gender, age, race, disability, income, location, educational level, marital status, number of children, etc. Behavioral characteristics of the viewers may include information related to hobbies, web browsing behaviors, purchasing behaviors, interests, etc. Historical data 310 may also include historical prices, number of historical sales, and historical revenue associated with web page 215, a web site that contains web page 215, advertising space 200, and/or a particular ad.

In another exemplary embodiment, forecast engine 300 may be configured to provide a forecast of one or more future values associated with advertising, for example, a future value associated with advertising space 200, based on at least a portion of historical data 310. In one embodiment, forecast engine 300 may be configured to provide a forecast of an available targeted inventory (e.g., a number of available targeted impressions) associated with advertising space 200. The available targeted inventory associated with advertising space 200 may correspond to a targeted population and may match one or more population composition rules. Forecast engine 300 may be configured to provide a forecasted revenue value associated with advertising space 200. The forecasted revenue value may be determined based on the available targeted inventory forecasted by forecast engine 300. Further, forecast engine 300 may be configured to perform other functions associated with advertising, such as, for example, forecasting a supply versus demand for impressions based on historical data 310 and/or current market data.

In another exemplary embodiment, forecast engine 300 may forecast a future value associated with advertising space 200 based on at least one or more targeted advertising rules 320. The one or more targeted advertising rules 320 may include, for example, one or more population composition rules. The population composition rules, in turn, may include one or more demographic characteristics of the viewers, such as, for example, race, age, gender, number of children, location, educational level, and disability. A population composition rule may contain one or more variables, each variable corresponding one or more demographic characteristics and/or behavioral characteristics, and each variable having one or more associated values. In other words, the population composition rule may place a condition or constraint on an impression (or view). For example, in one embodiment, a population composition rule may contain a variable “gender” and one or more values corresponding to the variable, such as, for example, “female” or “male.” Then, for example, using a population composition rule in which “gender=female,” an impression would be associated with a female viewer. In another embodiment, the population composition rule may contain a combination of two or more variables and their corresponding values, for example, “gender=female and age=20.” Then, for example, using a population composition rule in which “gender=female and age=20,” an impression would be associated with a 20-year old female viewer. In other embodiments, the population composition rule may not contain any variable and/or value corresponding to the variable, and may be referred to as a null rule. Thus, any impression may be associated with a null rule

Targeted advertising rules 320 such as population composition rules may be stored in storage device 120. Forecast engine 300 may obtain one or more targeted advertising rules 320 when performing forecasting of one or more future values associated with advertising space 200. Targeted advertising rules 320 may also be encoded in code or software programs executable by forecast engine 300 and/or CPU 110 for predicting a future value associated with advertising space 200.

Forecast engine 300 may utilize one or more models 330 for forecasting future values associated with advertising space 200. Models 330 may provide information for predicting and determining prices for a predetermined ad and/or advertising space 200. Using models 330, forecast engine 300 may model one or more demographic and/or behavioral characteristics as variables.

In one exemplary embodiment, models 330 may include one or more time series modeling factors, such as, for example, impression level, trend, and/or seasonality associated with advertising space 200. For example, models 330 may model “gender” as a variable, which corresponds to a value of “female” or “male.” Models 330 may model “age” as a variable, which corresponds to a predetermined value. For example, “age=1” may indicate that the viewer's age is within a range 1, which is 20-30 years old. Models 330 may model “BuysOnline” as a variable, which may correspond to a value of, for example, 1 or 0. For example, “BuysOnline=1” may indicate that viewers make online purchases, and “BuysOnline=0” may indicate that viewers do not make online purchases.

Forecast engine 300 may apply one or more predetermined targeted advertising rules, such as, for example, population composition rules to models 330 to analyze historical data 310, and/or to forecast future values associated with advertising space 200. For example, forecast engine 300 may apply a rule that requires “gender=female; age=1; and BuysOnline=0” in analyzing historical data 310 to obtain a number of impressions that match the rule.

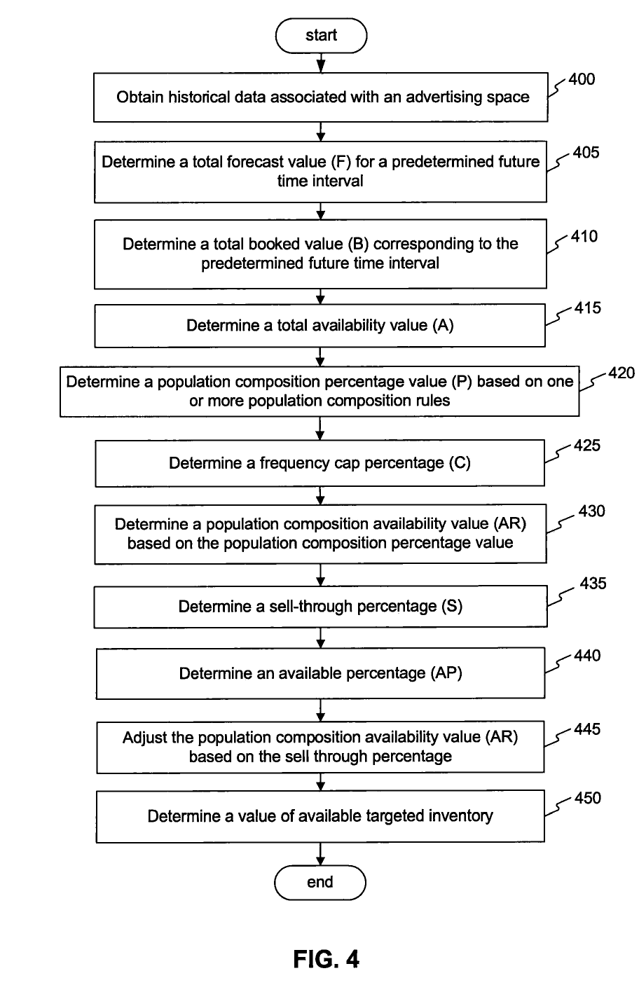

FIG. 4 is a flow chart illustrating an exemplary method of forecasting an available targeted inventory, which may be implemented by system 100. In one exemplary embodiment, the method of FIG. 4 may be implemented by forecast engine 300 of system 100. Forecast engine 300 may use one or more components such as, for example, memory 115 configured to store program code to perform the method of FIG. 4, and CPU 110, configured to execute program code to perform the method of FIG. 4. To provide a forecast of the available targeted inventory, forecast engine 300 may obtain historical data 310 associated with an advertising space (400), such as, for example, advertising space 200 shown in FIG. 2. Forecast engine 300 may analyze historical data 310, which may include at least a view count associated with advertising space 200.

Forecast engine 300 may determine a total forecast value F for a predetermined interval of future time (405). The predetermined interval of future time may be associated with a purchase of impressions proposed by the marketer to the online advertising service provider, and may be any suitable time interval, for example, one day, two months, or three years. Total forecast value F may indicate the total available absolute inventory, i.e., a total number of impressions available for sale associated with advertising space 200. The absolute inventory may not account for existing purchases of impressions. In one embodiment, total forecast value F may be determined based on historical data 310. For example, total forecast value F may be determined based on historical view counts (historical impressions) associated with advertising space 200.

Forecast engine 300 may determine a total booked value B corresponding to the predetermined interval of future time (410). Total booked value B may indicate a total number of impressions that have been sold (booked) and, therefore, may not be available for sale at the predetermined interval of future time. Total booked value B may be determined based on a booking history. For example, total booked value B may be determined based on data included in historical data 310 indicating the number of impressions that have been booked.

Forecast engine 300 may determine a total availability value A (415). Total availability value A may indicate a total available inventory (i.e., available number of impressions) for sale at the predetermined interval of future time. Total availability value A may be determined based on at least one of total booked value B and total forecast value F. In one embodiment, total availability value A may be determined by subtracting total booked value B from total forecast value F, e.g., A=F−B. Other methods for determining total availability value A may also be implemented.

In one exemplary embodiment, proposed purchases of impressions made by the marketer may be targeted at a particular population. That is, the marketer may require impressions to match one or more population composition rules, which may include, for example, demographic and/or behavioral characteristics associated with the viewers. Forecast engine 300 may determine a population composition percentage value P based on one or more population composition rules (420).

In one embodiment, population composition percentage value P may be determined by sampling historical data 310. For example, forecast engine 300 may sample one or more advertising logs included in historical data 310, which may include population composition information associated with the ad viewers. The advertising log may include information related to the demographic and/or behavioral characteristics of the viewers, such as, for example, gender, race, age, location, education, and income. The advertising log may also contain information related to the marital status of the viewers, whether the viewers have children and the number of children each viewer has, whether the viewers make online purchases, and any other suitable information associated with the demographic and/or behavioral characteristics of the viewers.

Forecast engine 300 may analyze historical data 310, for example, sampling the historical data 310 while applying the one or more population composition rules to obtain a total number of impressions (view counts) that match the predetermined population composition rules. Population composition percentage value P may be determined by dividing the total number of impressions that match the predetermined population composition rules by a total number of impressions. The total number of impressions may include both impressions that match the rules and impressions that do not match the rules. If the proposed purchase of impressions is an untargeted purchase, i.e., if the proposed purchase does not specify any population composition rule, population composition percentage value P may be specified to be a predetermined value, for example, P=1.0 or 100%.

Forecast engine 300 may determine a frequency cap percentage C associated with advertising space 200 (425). If a frequency cap is specified in the proposed purchase of impressions corresponding to the predetermined interval of future time, frequency cap percentage C may be determined based on historical data 310. For example, forecast engine 300 may sample the advertising log included in historical data 310 to obtain a total number of impressions that match the requirement set by the specified frequency cap. Frequency cap percentage C may be determined by dividing the total number of impressions that match a requirement set by the frequency cap, by the total number of impressions (including impressions that meet and that do not meet the requirement set by the frequency cap). In one embodiment, if the frequency cap is not specified in the proposed purchase made by the marketer, forecast engine 300 may specify frequency cap percentage C to be a predetermined value, for example, C=1.0 or 100%.

Forecast engine 300 may determine a population composition availability value AR based on population composition percentage value P (430). In one embodiment, population composition availability value AR may be determined based on at least one of population composition percentage value P, total availability value A, and frequency cap percentage C. For example, forecast engine 300 may multiply total availability value A with population composition percentage value P and frequency cap percentage C to obtain a percentage availability value PAV (e.g., PAV=A*P*C). Percentage availability value PAV may be used to generate population composition availability value AR. For example, forecast engine 300 may determine population composition availability value AR as a function of the percentage availability value. In one embodiment, population composition availability value AR may be equal to percentage availability value PAV, i.e., AR=PAV=A*P*C.

Forecast engine 300 may determine a sell-through percentage S (435). Sell-through percentage S may indicate how many impressions have been sold and, therefore, may not be available for sale corresponding to the predetermined interval of future time. Sell-through percentage S may be determined based on at least one of total booked value B and total forecast value F. In one embodiment, if at least one of population composition percentage value P and frequency cap percentage C is less than a predetermined value, e.g., 1.0 (i.e., P<1.0 or C<1.0), sell-through percentage S may be determined by dividing total booked value B by total forecast value F, e.g., S=B/F. If both of population composition percentage value P and frequency cap percentage value C are not less than the predetermined value, such as, for example, 1.0, then forecast engine 300 may specify sell-through percentage S to be a predetermined value. In one embodiment, if P=1.0 and C=1.0, forecast engine 300 may specify sell-through percentage S to be 0.0.

Forecast engine 300 may determine an available percentage AP based on sell-through percentage S (440). Available percentage AP may indicate the percentage of the total impressions available after taking into account sell-through percentage S. Available percentage AP may be determined by subtracting sell-through percentage S from a predetermined value, for example, AP=1−S. Other methods for determining available percentage AP based on sell-through S may also be implemented.

Forecast engine 300 may adjust population composition availability value AR based on sell-through percentage S (445). Forecast engine 300 may adjust population composition availability value AR based on available percentage AP, which may be determined based on sell-through percentage S. In one embodiment, population composition availability value AR may be adjusted by multiplying available percentage AP, i.e., AR′=AR*AP, where AR′ is an adjusted population composition availability value. As a result, in one embodiment, the adjustment may reduce population composition availability value AR (i.e., AR′<AR), if AP<1.0.

Forecast engine 300 may determine the value of available targeted inventory (targeted impressions) based on the adjusted population composition availability value AR′ (450). In one embodiment, forecast engine 300 may determine that the value of available targeted inventory to be equal to adjusted population composition availability value AR′, or to be a function of adjusted population composition availability value AR′.

When the marketer proposes the purchase of impressions associated with advertising space 200, the online advertising service provider may utilize forecasted output 340 generated by forecast engine 300 to determine whether to accept the proposed purchase. Forecast engine 300 may compare the forecasted value of available targeted inventory with the total number of impressions requested by the marketer in the proposed purchase. If the forecasted value of available targeted inventory is less than the number of impressions in the proposed purchase for the predetermined interval of future time, the proposed purchase may be rejected. If the forecasted value of available targeted inventory is equal to or greater than the number of impressions in the proposed purchase for the predetermined interval of future time, the proposed purchase may be accepted. Alternatively, in one embodiment, if a difference between the forecasted value of available targeted inventory and the number of impressions in the proposed purchase is within a predetermined range, the proposed purchase may be accepted. Otherwise, if the difference between the forecasted value of available targeted inventory and the number of impressions in the proposed purchase falls outside the predetermined range, the proposed purchase may be rejected.

Steps 400-450 may not necessarily follow the order shown in FIG. 4. For example, forecast engine 300 may determine total booked value B (410) before determining total forecast value F (405). Also for example, forecast engine 300 may determine population composition percentage value P (420) before determining the total availability value A (415).

An example is provided below to illustrate the method shown in FIG. 4. Table 1 shows a portion of historical data 310 associated with advertising space 200. In one exemplary embodiment, the data shown in Table 1 is the data obtained by sampling raw data over a predetermined interval of historical time at a predetermined sampling rate. In other embodiments, the data shown in Table 1 may be the raw data.

TABLE 1
Exemplary Historical Data

| Impressions | Gender | Age | BuysOnline |
|---|---|---|---|
| 10000 | f | 1 | 0 |
| 5000 | f | 2 | 1 |
| 20000 | f | 3 | 0 |
| 7500 | m | 1 | 0 |
| 15000 | m | 2 | 1 |
| 16000 | m | 3 | 0 |

In Table 1, the first column indicates the number of impressions in each sample. Thus, the total number of impressions over the sampling period is the sum of the values in the first column, which is 10000+5000+20000+7500+15000+16000=74500. In this example, the total forecast value F is assumed to be identical to the total number of impressions in the sampled historical data, i.e., 74500. In the second column, “f” represents female, and “m” represents male. In the third column, the values 1, 2, or 3 corresponding to the variable “age” may represent different age ranges. For example, age=1 may represent a first age range, such as, for example, 30-40 years old, and age=2 may represent a second age range, for example, 41-50 years old. The variable “BuysOnline” indicates a viewer's behavioral characteristic, i.e., whether the viewer makes online purchases. “BuysOnline=0” indicates that the viewer does not make any online purchases, or does not make any online purchases after viewing a particular ad. “BuysOnline=1” indicates that the viewer makes one or more online purchases, or makes one or more online purchases after viewing the particular ad.

In this example, the marketer may propose to the online advertising service provider a purchase of impressions corresponding to a predetermined interval of future time. For example, the marketer may propose to buy 5000 impressions. The 5000 impressions may be associated with predetermined population composition rules. For example, the proposed purchase of 5000 impressions may be targeted at a population that satisfies “gender=m and BuysOnline=0.”

Some impressions associated with advertising space 200 may have already been purchased. The existing purchases may or may not correspond to the predetermined interval of future time associated with the proposed purchase. In this example, the existing purchases may include the following four purchases expressed in the form of a number of impressions followed by a population composition rule:

(1) 8000 impressions: gender=f;

(2) 12000 impressions: age=3;

(3) 3500 impressions: age=2 and BuysOnline=1; and

(4) 25000 impressions: -.

The symbol “-” used in the existing purchase (4) may indicate that no population composition rule is associated with the existing purchase (4), or in other words, existing purchase (4) is untargeted. Total booked value B may be determined from the existing purchases. For example, Total booked value B may be the sum of the impressions from all existing purchases (1)-(4).

The following exemplary steps illustrate calculations performed by forecast engine 300 associated with the method shown in FIG. 4 for this example. It is noted that the order of the steps is for illustrative purposes only, and is not limited to the order listed below.

Step (1): Calculate total booked value B=8000+12000+3500+25000=48500;

Step (2): Calculate total forecast value F=74500;

Step (3): Calculate population composition percentage value P=(7500+16000)/74500=0.33;

Step (4): Calculate frequency cap percentage C=1.0;

Step (5): Calculate total availability value A=74500−48500=26000;

Step (6): Calculate population composition availability value AR=26000*0.33*1.0=8580;

Step (7): Calculate sell-through percentage S=48500/74500=0.65;

Step (8): Calculate available percentage AP=1.0−0.65=0.35;

Step (9): Adjust population composition availability value AR′=8580*0.35=2984.

Forecast engine 300 may determine that the value of available targeted inventory is equal to adjusted population composition availability value AR′. As shown in Step (9), adjusted population composition availability value AR′ is 2984. Forecast engine 300 may further determine whether the proposed purchase is to be accepted. Forecast engine 300 may also accept the proposed purchase depending on acceptance/rejection criteria that are adopted. In this example, the proposed purchase includes 5000 impressions, while the value of available targeted inventory is 2984. Thus, forecast engine 300 may reject the proposed purchase of 5000 impressions.

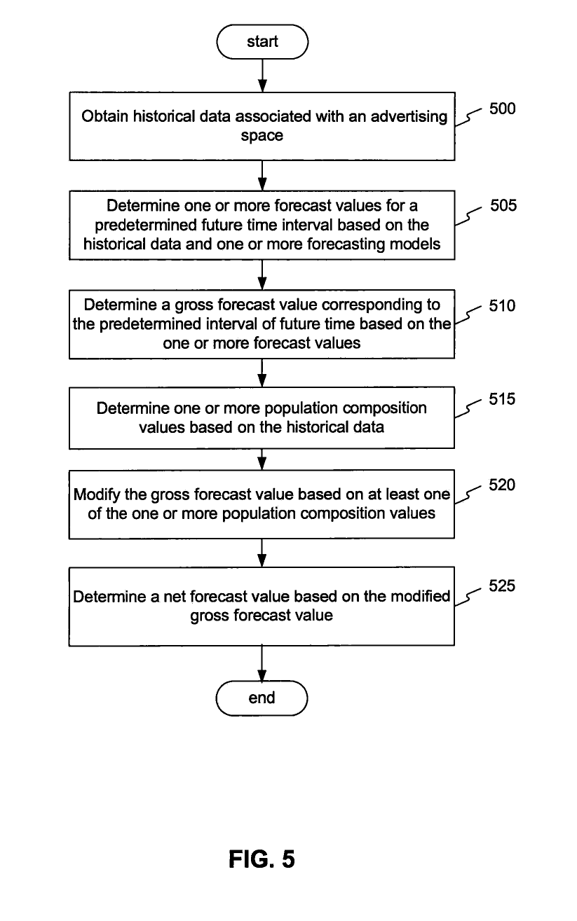

FIG. 5 is a flow chart illustrating an exemplary method for obtaining a forecasted inventory value, associated with an advertising space, for example, advertising space 200, and corresponding to a targeted population. The forecasted inventory value may be denoted as Y. The method may be implemented through system 100. In one embodiment, the exemplary method for obtaining the forecasted inventory value may be implemented by forecast engine 300 of system 100. Forecast engine 300 may utilize CPU 110 encoded with program code to perform the method of FIG. 5.

The forecasted inventory value Y may be a function of one or more variables. In one embodiment, the forecasted inventory value Y may be a function of a gross forecast G of available inventory, and a targeted population estimate Pt, e.g., Y=f(G, Pt), where f( ) stands for a function. The variables, gross forecast G and targeted population estimate Pt, may be dependent on one another, or may be independent from one another. In one embodiment, gross forecast G and targeted population estimate Pt may be independent variables.

Each of gross forecast G and targeted population estimate Pt may be determined based on one or more factors. The factors may include, for example, time series factors associated with advertising space 200, such as impression level, trend, and seasonality, and population factors associated with the viewers, such as, for example, population composition and targeted impression competition.

To obtain the forecasted inventory value Y, forecast engine 300 may obtain historical data 310 for analysis (500). As discussed above in connection with FIG. 3, historical data 310 may include raw, un-sampled historical data, sampled historical data, or any combination thereof. In one embodiment, for example, forecast engine 300 may obtain and analyze a raw, un-sampled view count included in historical data 310 associated with advertising space 200.

Forecast engine 300 may determine one or more forecast values for a predetermined interval of future time based on historical data 310 and one or more forecasting models (505). The one or more forecast values may include any suitable values, such as, for example, values indicating impression level, trend, population composition, etc. The one or more forecasting models may include any suitable models, such as, for example, time series models and statistic models. In one embodiment, time series factors such as impression level, trend, and seasonality or the like may be estimated using time series models. The population factors, such as population composition and targeted impression competition, may be probabilistic in nature, and may be estimated through statistic models. However, the statistic models may increase the complexity of the forecasting method and the cost of operating system 100.

In one embodiment, population factors, such as population composition and targeted impression competition, may be estimated as a percentage of one or more time series factors. In other embodiments, the population factors may be estimated as a predetermined percentage of the daily impression count. The predetermined percentage may be, for example, a constant percentage.

Forecast engine 300 may determine, for the predetermined interval of future time, gross forecast G based on the one or more forecast values (510). The calculation of gross forecast G may also be based on historical data 310. For example, forecast engine 300 may determine gross forecast G based on at least one of the forecast values of the time series factors, including at least one of impression level, trend, and/or seasonality, which may be forecasted based on historical data 310. It is contemplated that gross forecast G may also be determined based on other forecast values not listed above.

Forecast engine 300 may determine one or more population composition values, which may indicate one or more population factors, such as, for example, the population composition and/or the targeted impression competition (515). The one or more population composition values may also be referred to as rule values. The population composition values may be determined based on at least one of a demographic variable, such as, for example, gender, and a value corresponding to the demographic variable, such as, for example, female. In one embodiment, the population composition values may be determined based on a combination of a demographic variable and a value corresponding to the demographic variable, for example, “gender=female; and age=20.” In one embodiment, the population composition values may be determined based on at least one of a demographic variable and a behavioral variable, for example, “BuysOnline=1,” or “gender=female; and BuysOnline=1.”

The population composition values may include targeted population estimate Pt. In one embodiment, targeted population estimate Pt may be determined as a function of a result of at least one of the time series factors. For example, targeted population estimate Pt may be a predetermined percentage of gross forecast value G, which may be estimated by suitable time series models. The predetermined percentage may be a constant percentage.

Referring back to FIG. 5, forecast engine 300 may modify gross forecast G based on at least one of the one or more population composition values (520). In one embodiment, gross forecast G may be modified by multiplying at least one of the one or more population composition values, such as, for example, targeted population estimate Pt, to obtain a modified gross forecast G′, i.e., G′=G*Pt.

Forecast engine 300 may determine a net forecast value based on modified gross forecast G′ (525). In one embodiment, the net forecast value may be a function of modified gross forecast G′. In one embodiment, the net forecast value may be equal to modified gross forecast G′.

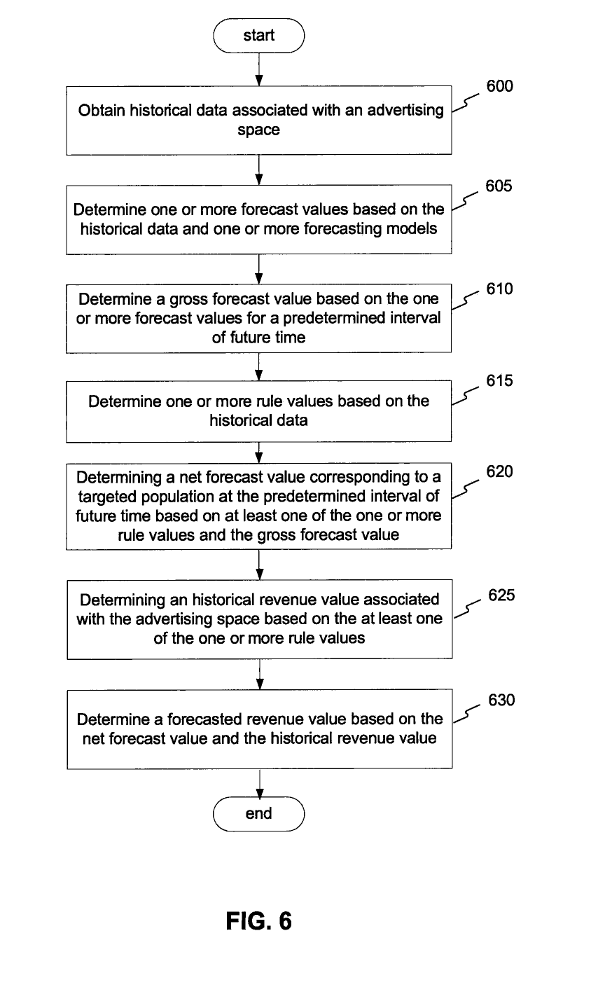

FIG. 6 is a flow chart illustrating an exemplary method for forecasting revenue associated with an advertising space, such as advertising space 200. The exemplary method may be implemented by system 100. In one embodiment, the exemplary method may be implemented by forecast engine 300 of system 100. Forecast engine 300 may use memory 115 configured to store program code to perform the method of FIG. 5, and CPU 110 configured to execute the program code to perform the method of FIG. 6.

Forecast engine 300 may obtain and analyze historical data 310 associated with advertising space 200 obtained, for example, from storage device 120 shown in FIG. 1 (600). Historical data 310 may include at least a view count, which may be based on any suitable time interval, such as a daily view count, an hourly view count, etc. As discussed above in connection with FIGS. 3 and 5, historical data 310 may include raw, un-sampled historical data, sampled historical data, or any combination thereof. The historical data 310 may include, for example, a raw, un-sampled view count and/or sampled view count associated with advertising space 200 and/or a predetermined ad.

Forecast engine 300 may determine, based on historical data 310 and one or more forecasting models, one or more forecast values (605). The one or more forecast values may be similar to the one or more forecast values discussed with reference to FIG. 5. The one or more forecasting models may be similar to the models discussed with reference to FIGS. 3 and 5. The determination process of the one or more forecast values in step 605 may be similar to that discussed with reference to step 505 of FIG. 5.

Forecast engine 300 may determine, for a predetermined interval of future time, a gross forecast value based on the one or more forecast values (610). The gross forecast value of step 610 may be similar to the gross forecast G discussed with reference to FIG. 5, and the determination process of the gross forecast value in step 610 may be similar to that discussed with reference to step 510 of FIG. 5.

Forecast engine 300 may determine one or more rule values based on historical data 310 (615). The rule values of step 615 may be similar to the population composition values discussed with reference to FIG. 5, and the determination process of the rule values of step 615 may also be similar to that discussed with reference to step 515 of FIG. 5. For example, the rule values may be determined based on a percentage of the view count. The rule values may also be determined based on at least one of a demographic variable and a behavioral variable. The rule values may also be determined based on a combination of a demographic variable and a value corresponding to the demographic variable.

Forecast engine 300 may determine a net forecast value corresponding to a targeted population at the predetermined interval of future time based on at least one of the one or more rule values and the gross forecast value (620). The net forecast value of step 620 may be similar to the net forecast value discussed with reference to FIG. 5, and the determination process of may also be similar to that discussed with reference to step 525 of FIG. 5. For example, the net forecast value may be determined by multiplying at least one of the one or more rule values determined with reference to step 615 with the gross forecast value determined with reference to step 610.

Forecast engine 300 may determine an historical revenue value associated with advertising space 200 based on the at least one of the one or more rule values (625). Determination of the historical revenue may also be based on at least one of the one or more rule values and historical data, including historical price information associated with advertising space 200. For example, historical revenue value may be determined by multiplying the total number of historical impressions with one or more historical prices associated with the historical impressions.

Forecast engine 300 may determine, based on the net forecast value and the historical revenue value, a forecasted revenue value associated with advertising space 200 (630). The determination of the forecasted revenue value may utilize one or more models, such as, for example, the time series models discussed with reference to FIG. 3. The forecasted revenue value may be modeled as a function of the historical revenue value and the net forecast value. Forecast engine 300 may multiply the net forecast value, which may indicate the net forecast of available targeted inventory, by a forecasted price, which may be generated by forecast engine 300. The forecasted price may be determined from the historical revenue value, the historical price information contained in the historical data, or a forecasted demand and supply relationship in the advertising market.

The system and method of the present disclosure may be employed in any advertising systems, for example, online advertising systems. The disclosed system and method may provide forecasting of a variety of future values associated with an advertising space. For example, the disclosed system and method may provide a forecast of an available targeted inventory or impressions for a predetermined interval of future time. The disclosed system and method may also provide a forecast of future revenue associated with the advertising space for the predetermined interval of future time. As a result, the disclosed system and method may provide more accurate forecasting of targeted inventory, advertising revenue, and/or advertising price.

It will be apparent to those skilled in the art that various modifications and variations can be made in the system and method of the present disclosure without departing from the scope of the disclosure. Other embodiments will be apparent to those skilled in the art from consideration of the specification and practice of the system and method disclosed herein. It is intended that the specification and examples be considered as exemplary only, with a true scope of the invention being indicated by the following claims and their equivalents.

1. A computer-implemented method for forecasting a value of an available targeted inventory associated with an advertising space, comprising:
obtaining historical data associated with the advertising space;
determining, by a processor, for the advertising space, a total forecast value corresponding to a predetermined interval of future time, wherein the total forecast value is based on the historical data;
determining, by the processor, for the advertising space, a total booked value corresponding to the predetermined interval of future time;
determining, by the processor, for the predetermined interval of future time, a total availability value based on the total booked value and the total forecast value;
determining, by the processor, for the advertising space, a population composition percentage value based on one or more population composition rules;
determining, by the processor, for the predetermined interval of future time, a population composition availability value based on the population composition percentage value; and
determining, by the processor, the value of the available targeted inventory associated with the advertising space for the predetermined interval of future time based on the population composition availability.

2. The computer-implemented method of claim 1, wherein obtaining the historical data includes:
obtaining a view count associated with the advertising space,
wherein the view count includes at least one of a value representing a raw historical view count and a value representing a sampled historical view count.

3.-5. (canceled)

6. The computer-implemented method of claim 1, wherein when a proposed purchase associated with the advertising space is a targeted purchase associated with one or more population composition rules, determining the population composition percentage value includes:
sampling the historical data;
determining, from the sampled historical data, a number of view counts that match the one or more population composition rules;
determining a total number of view counts included in the sampled historical data; and
dividing the number of view counts that match the one or more population composition rules by the total number of view counts included in the sampled historical data.

7. The computer-implemented method of claim 1, wherein when a proposed purchase associated with the advertising space is an untargeted purchase not associated with a population composition rule, determining the population composition percentage value includes:
specifying the population composition percentage value to be a predetermined value.

8. The computer-implemented method of claim 1, further including:
determining a frequency cap percentage based on at least one of the historical data and a frequency cap associated with the advertising space.

9. The computer-implemented method of claim 8, wherein when the frequency cap is predetermined, determining the frequency cap percentage includes:
sampling the historical data;
determining, from the sampled historical data, a number of view counts that match a requirement set by the predetermined frequency cap;
determining a total number of view counts included in the sampled historical data; and
dividing the number of view counts that match the requirement set by the predetermined frequency cap by the total number of view counts.

10. (canceled)

11. The computer-implemented method of claim 8, wherein determining the population composition availability value based on the population composition percentage value includes:
multiplying the total availability value by the population composition percentage value and the frequency cap percentage; and
generating the population composition availability value based on the multiplying.

12. The computer-implemented method of claim 1, further including determining a sell-through percentage based on at least one of the population composition percentage value, a frequency cap percentage, the total booked value, and the total forecast value,
wherein determining the sell-through percentage includes:
dividing, when at least one of the population composition percentage value and the frequency cap percentage is less than a predetermined value, the total booked value by the total forecast value; and
specifying, when at least one of the population composition percentage value and the frequency cap percentage is greater than a predetermined value, the sell-through percentage to be a predetermined value.

13.-17. (canceled)

18. The computer-implemented method of claim 1, wherein determining the total forecast value includes:
determining the total forecast value based on one or more time series models and the historical data.

19. The computer-implemented method of claim 1, wherein determining the total booked value includes:
determining the total booked value based on a booking history associated with the advertising space.

20.-29. (canceled)

30. A computer-implemented method for forecasting revenue associated with an advertising space, comprising:
obtaining historical data associated with the advertising space;
determining, by a processor, one or more forecast values based on the historical data and one or more forecasting models;
determining, by a processor, a gross forecast value based on the one or more forecast values for a predetermined interval of future time;
determining, by the processor, one or more rule values based on the historical data;
determining, by the processor, a net forecast value corresponding to a targeted population at the predetermined interval of future time based on at least one of the one or more rule values and the gross forecast value;
determining, by the processor, an historical revenue value associated with the advertising space based on the at least one of the one or more rule values; and
determining, by a processor, a forecasted revenue value based on the net forecast value and the historical revenue value for the predetermined interval of future time.

31. The computer-implemented method of claim 30, wherein determining the net forecast value includes:
multiplying at least one of the one or more rule values with the gross forecast value.

32. The computer-implemented method of claim 30, wherein obtaining the historical data includes:
obtaining a view count.

33. The computer-implemented method of claim 32, wherein obtaining the view count includes:
obtaining at least one of a daily view count and an hourly view count.

34. The computer-implemented method of claim 32, wherein obtaining the view count includes:
obtaining at least one of a raw value of the view count and a sampled value of the view count.

35. The computer-implemented method of claim 32, wherein determining the one or more rule values includes:
determining the one or more rule values based on the view count.

36. The computer-implemented method of claim 30, wherein obtaining the historical data includes:
obtaining at least one of raw historical data and sampled historical data.

37. The computer-implemented method of claim 30, wherein determining the one or more rule values includes:
determining the one or more rule values based on a combination of a demographic variable and a value corresponding to the demographic variable.

38. The computer-implemented method of claim 30, wherein determining the one or more rule values includes:
determining the one or more rule values based on at least one of a demographic variable and a behavioral variable.

39. A computer readable medium embodying a computer program product, the computer program product comprising computer program code configured to cause a computing device to perform a method for forecasting a value of available targeted inventory associated with an advertising space, the method comprising:
obtaining historical data associated with the advertising space;
determining, for the advertising space, a total forecast value corresponding to a predetermined interval of future time, wherein the total forecast value is based on the historical data;
determining, for the advertising space, a total booked value corresponding to the predetermined interval of future time;
determining, for the predetermined interval of future time, a total availability value based on the total booked value and the total forecast value;
determining, for the advertising space, a population composition percentage value based on one or more population composition rules;
determining, for the predetermined interval of future time, a population composition availability value based on the population composition percentage value; and
determining the value of the available targeted inventory associated with the advertising space for the predetermined interval of future time based on the population composition availability.

40. (canceled)
